(19) United States
(12) Patent Application Publication
(10) Pub. No.: US 2009/0097443 A1
(43) Pub. Date: Apr. 16, 2009

(54) Hierarchical Network Operating Mode in a Wireless Communications Network

(76) Inventors: Pirjo Marjaana Pasanen, Vantaa (FI); Heikki Berg, Viiala (FI); Jarkko Kneckt, Espoo (FI)

Correspondence Address: SLATER & MATSIL, L.L.P., 17950 PRESTON RD, SUITE 1000, DALLAS, TX, 75252-5793, US

(21) Appl. No.: 12/248,772

(22) Filed: Oct. 9, 2008

Related U.S. Application Data
(60) Provisional application No. 60/979,009, filed on Oct. 10, 2007.

(51) Int. Cl. H04W 4/00

(52) U.S. Cl. 370/329

(57) ABSTRACT

A system and method for a hierarchical network operating mode in an ad hoc wireless communications network. In one embodiment, a communications node includes a controller and a transceiver. The controller is configured to create a bandwidth allocation request for other communications nodes in an ad hoc wireless communications network. The transceiver is configured to receive request grants from the other communications nodes granting the bandwidth allocations in accordance with the bandwidth allocation request, thereby establishing a hierarchical network operating mode in at least a portion of the ad hoc wireless communications network.

This application claims the benefit of U.S. Provisional Application No. 60/979,009 entitled “Hierarchical Network Operating Mode in a Wireless Communications Network,” filed on Oct. 10, 2007, which is incorporated herein by reference.

### TECHNICAL FIELD

The present invention relates to communication systems and, more particularly, to a system and method for a hierarchical network operating mode in an ad hoc wireless communications network.

### BACKGROUND

An ad hoc wireless communications network may be a communications network that communicates wirelessly without the assistance of a wired infrastructure. Furthermore, communications nodes in an ad hoc wireless communications network may communicate directly without communicating through an intermediary wireless communications node. An ad hoc wireless communications system may be thought of as a distributed system. The elimination of a wired infrastructure and intermediaries may enable rapid and inexpensive deployments of ad hoc wireless communications networks. For example, ad hoc wireless communications networks compliant with the Institute of Electronic and Electrical Engineers (“IEEE”) standard 802.16 directed to broadband wireless access (including worldwide interoperability for microwave access (“WiMAX”)), which is incorporated herein by reference, may be brought rapidly into service in metropolitan areas without requiring a large investment in infrastructure such as required in a cellular-based communications system. Similarly, the IEEE standard 802.11 directed to wireless local area networks (including wireless fidelity (“Wi-Fi”)), which is incorporated herein by reference, offers a different set of technical specifications for ad hoc wireless communications networks.

Ad hoc wireless communications networks may make use of a distributed communications channel reservation system. The distributed nature thereof may enable flexibility and scalability, especially when the number of communications nodes in the ad hoc wireless communications networks becomes very large.

In contrast, cellular-based communications systems generally offer good performance with short and predictable delays and high throughput due to their structured infrastructure. Relay stations in a cellular-based communications system typically employ a hierarchical network topology with centralized control. This may afford efficient use of available resources and protection against collisions.

Accordingly, what is needed in the art is a system and method for a hierarchical network operating mode in an ad hoc wireless communications network.

### SUMMARY OF THE INVENTION

In accordance with an embodiment, a system and method is provided for a hierarchical network operating mode in an ad hoc wireless communications network. In one embodiment, a communications node includes a controller and a transceiver. The controller is configured to create a bandwidth allocation request for other communications nodes in an ad hoc wireless communications network. The transceiver is configured to receive request grants from the other communications nodes granting the bandwidth allocations in accordance with the bandwidth allocation request, thereby establishing a hierarchical network operating mode in at least a portion of the ad hoc wireless communications network.

In another aspect, the present invention provides an apparatus (e.g., controller) for use in an ad hoc wireless communications network. In one embodiment, the apparatus includes a bandwidth calculator configured to compute bandwidth allocations. A frame creator of the apparatus is configured to format frames for use in requesting the bandwidth allocations from communications nodes in the ad hoc wireless communications network to create a hierarchical network. The apparatus also includes a multi-phase communications unit configured to control transmissions between the communication nodes as a function of a phase of a phased communications mode in the hierarchical network.

The foregoing has outlined rather broadly features as described herein such that the detailed description of some of the embodiments that follow may be better understood. Additional features of the embodiments will be described hereinafter, which form the subject of the claims as set forth below. It should be appreciated by those skilled in the art that the conception and specific embodiments disclosed may be readily utilized as a basis for modifying or designing other structures or processes for carrying out the same purposes as described herein. It should also be realized by those skilled in the art that such equivalent constructions do not depart from the spirit and scope as set forth in the appended claims.

### BRIEF DESCRIPTION OF THE DRAWINGS

For a more complete understanding of the embodiments, reference is now made to the following descriptions taken in conjunction with the accompanying drawings, in which:

FIG. 1 illustrates a diagram of an exemplary ad hoc wireless communications network in accordance with the principles of the present invention;

FIG. 2 illustrates a diagram of an exemplary frame structure for two consecutive frames for an IEEE standard 802.16 compliant ad hoc wireless communications network in accordance with the principles of the present invention;

FIG. 3 illustrates a diagram of an embodiment of a frame structure of an ad hoc wireless communications network with support for a hierarchical network overlaying the ad hoc wireless communications network in accordance with the principles of the present invention;

FIGS. 4a and 4b illustrate diagrams of an embodiment of a wireless communications device for use in an ad hoc wireless communications network in accordance with the principles of the present invention;

FIG. 5 illustrates a diagram of an embodiment of a hierarchical network overlaying an ad hoc wireless communications network in accordance with the principles of the present invention;

FIG. 6a illustrates a diagram of an embodiment of a sequence of events in creating a hierarchical network in an ad hoc wireless communications network in accordance with the principles of the present invention;

FIG. 6b illustrates a diagram of an embodiment of a sequence of events in adding a communications node to an existing hierarchical network in accordance with the principles of the present invention;

FIG. 7a illustrates a diagram of an embodiment of a high-level sequence of events in a phased communications mode of a hierarchical network overlaying an ad hoc wireless communications network in accordance with the principles of the present invention;

FIG. 7b illustrates a diagram of an embodiment of a sequence of events in a four-phased communications mode of a hierarchical network overlaying an ad hoc wireless communications network in accordance with the principles of the present invention;

FIG. 8a illustrates a diagram of an embodiment of a partitioning of a hierarchical network into two groups in accordance with the principles of the present invention;

FIGS. 8b through 8e illustrate diagrams of embodiments of permissible communications in each phase of a four-phased communications mode in accordance with the principles of the present invention; and

FIG. 9 illustrates a diagram of an embodiment of a packet flow using a four-phased communications mode in accordance with the principles of the present invention.

### DETAILED DESCRIPTION OF ILLUSTRATIVE EMBODIMENTS

The making and using of the embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The embodiments will be described in a specific context, namely an IEEE standard 802.16 compliant ad hoc wireless communications network. The invention may also be applied, however, to other wireless communications networks, such as those that are compliant to IEEE standard 802.11 technical standards. In general, the invention may be applied to any form of wireless communications network, such as sensor networks.

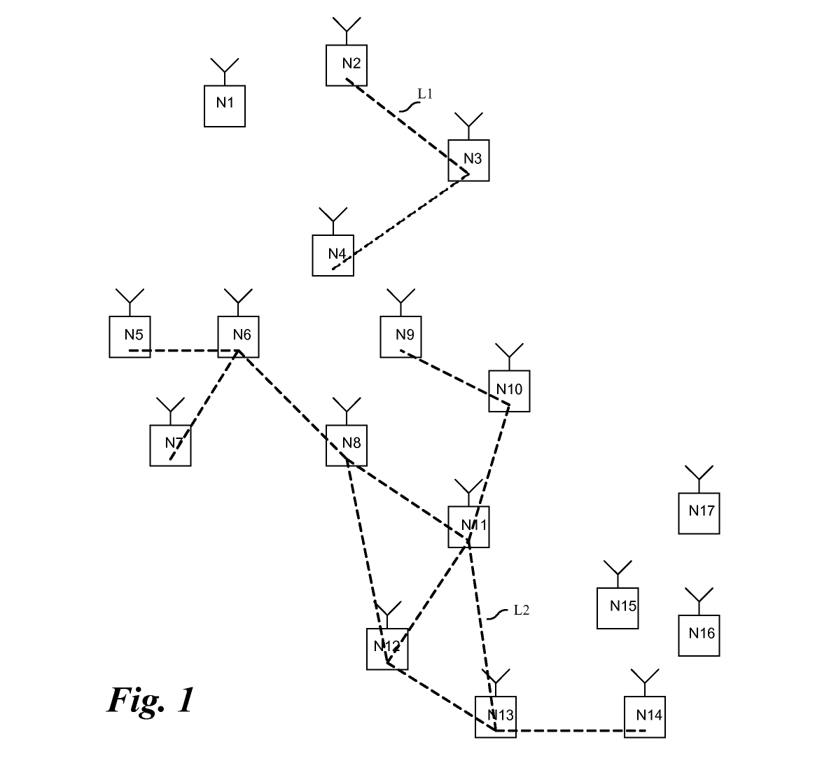

With reference now to FIG. 1, illustrated is a diagram of an exemplary ad hoc wireless communications network in accordance with the principles of the present invention. The ad hoc wireless communications network may be adherent to the IEEE standard 802.16. The ad hoc wireless communications network includes a plurality of communications nodes (designated N1 . . . N17). A first communications node may directly communicate wirelessly to a second communications node without requiring the assistance of a wired infrastructure or a wireless intermediary. For example, the communications node N2 may transmit directly to the communications node N3. Similarly, the communications node N11 may receive transmissions from the communications node N8.

Communications nodes may schedule transmissions with one another to help avoid transmission collisions. In an IEEE standard 802.16 compliant ad hoc wireless communications network, communications nodes may transmit transmission reservations at specified times to inform other communications nodes of their desire to transmit, size of transmission, intended recipient, and so forth. For the purposes of illustration, dashed lines illustrate transmissions between pairs of communications nodes. For example, dashed line L1 illustrates a transmission(s) between communications nodes N2 and N3 and dashed line L2 illustrates a transmission(s) between communications nodes N11 and N13.

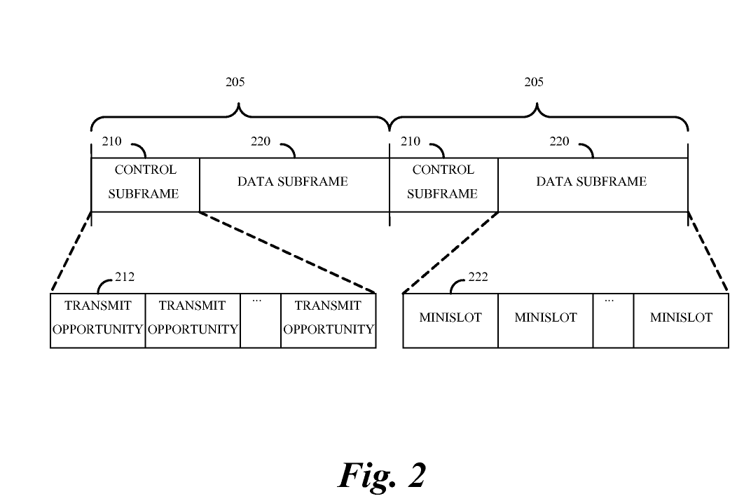

Turning now FIG. 2, illustrated is a diagram of an exemplary frame structure for two consecutive frames for an IEEE standard 802.16 compliant ad hoc wireless communications network in accordance with the principles of the present invention. A frame 205 in an IEEE standard 802.16 compliant ad hoc wireless communications network includes a control subframe 210 and a data subframe 220. The control subframe 210 may be used to create and maintain cohesion between different systems and to coordinate scheduling of data transfers. The control subframe 210 includes several transmit opportunities 212, while the data subframe 220 includes a plurality of minislots 222 that may be utilized by a communications node to transmit data. A minislot is a basic unit for bandwidth allocation, with a transmission occupying one or more minislots 222.

A communications node may transmit a scheduling message, referred to as a mesh distributed scheduling (“MSH-DSCH”) message, during a transmit opportunity 212 of the control subframe 210. The MSH-DSCH message may include a transmission type, transmission size (e.g., duration), intended recipient(s), and so forth. Other communications nodes in the ad hoc wireless communications network may listen to the MSH-DSCH message with the intended recipient(s) actually responding to the MSH-DSCH message with a responding message either granting or rejecting the scheduling message. The responding message from the intended recipient(s) may be transmitted using another transmit opportunity 212. The communications nodes that are not either the source or the destination of the transmissions may assume that the transmissions will complete successfully upon detection of a granting response message.

The frame structure as shown in FIG. 2 may be able to support a hierarchical network control or operating mode in an ad hoc wireless communications network. A transition to move from a distributed dynamic resource reservation mode (also referred to as an ad hoc network operating mode) to a hierarchical persistent mode (also referred to as a hierarchical network operating mode) may be announced in beaconing messages of the communications nodes. The beaconing messages may be transmitted during the control subframe 210. Once a hierarchical network operating mode is set up, a controlling node (also commonly referred to as a root communications node) may act like a base station to its sibling communications nodes. The root communications node may decide resource allocations and channel reservations for sibling communications nodes as well as announcing the allocations to the sibling communications nodes either in beacon transmissions or in-band signaling messages.

The basic resource reservation mechanism of an ad hoc wireless communications network (e.g., the use of beaconing messages sent by each communications node) may not need to be altered. Rather the mechanisms may employ a few modifications to permit a coexistence of the two operating modes and smooth transitions therebetween. Therefore, some of the communications nodes (or portions of the bandwidth thereof) in the ad hoc wireless communications network may operate using the hierarchical network operating mode, while other communications nodes may operate using the ad hoc network operating mode, and other communications nodes may operate using both. For instance, some portions of the control subframe 210 may be reserved for hierarchical network operating mode and other portions may be reserved for communications nodes operating in the ad hoc network operating mode.

For example, assuming that, in the ad hoc wireless communications network, beaconing logic forms a basis for operation. Then, each communications node may announce its presence and intentions to neighboring communications nodes by specific beaconing messages. The beacon messages may contain at least some type of communications node identifying parameter that may be used to identify the communications node transmitting the beacon messages. The ad hoc wireless communications network may use some sort of frame structure, such as shown in FIG. 2, with predefined time/frequency/code slots for beacon messages, data transfer, and other types of control messages.

The use of the hierarchical network operating mode may require that at least the communications nodes participating in the hierarchical network operating mode be able to synchronize their transmissions with sufficient accuracy. Similarly, the communications nodes using the ad hoc network operating mode may utilize a specified method for setting up pair-wise (or multicast) communications links between communications nodes. Furthermore, there may be some sort of routing mechanism for determining a route from a source communications node to a destination communications node, potentially through a number of intermediate communications nodes.

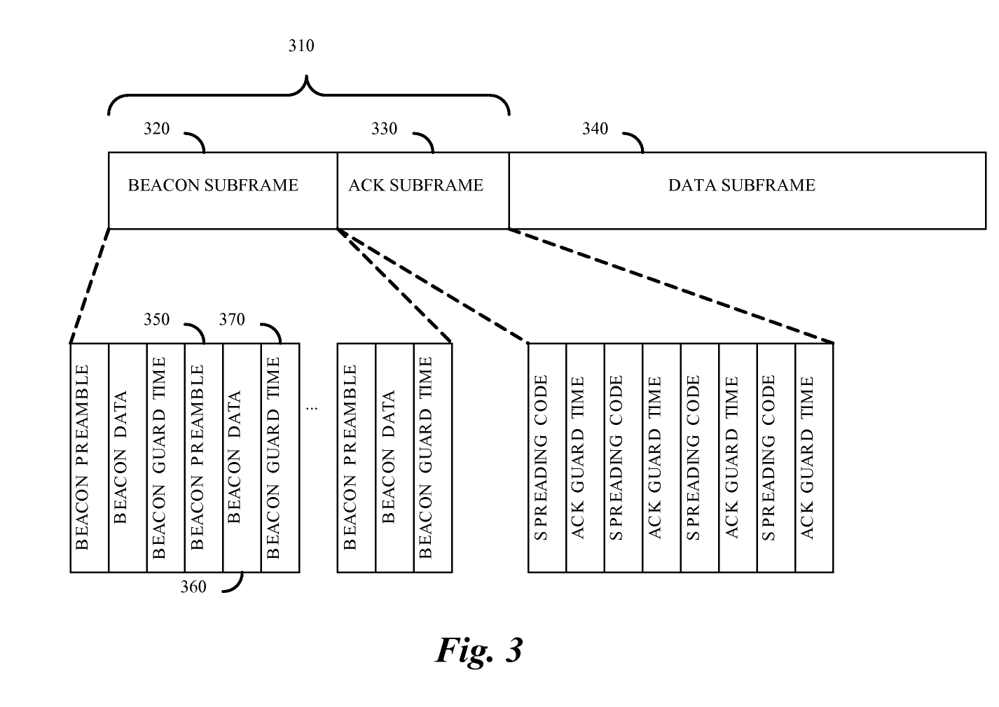

Turning now to FIG. 3, illustrated is a diagram of an embodiment of a frame structure of an ad hoc wireless communications network with support for a hierarchical network overlaying the ad hoc wireless communications network in accordance with the principles of the present invention. The frame structure may be an exemplary implementation of the frame structure 205 shown in FIG. 2 with additional support for accelerating the creation of a hierarchical network in the ad hoc wireless communications network. The frame structure includes a beacon subframe 320, an acknowledgement subframe 330, and a data subframe 340. The beacon subframe 320 and the acknowledgement subframe 330 make up a control subframe 310 analogous to the frame structure 205 of FIG. 2.

The beacon subframe 320 starts each frame in the ad hoc wireless communications network. The communications nodes in the ad hoc wireless communications network transmit a beacon in every frame. The beacon subframe 320 includes a beacon preamble 350, beacon data 360, and a beacon guard time 370. A communications node may use its transmission in the beacon subframe 320 to reserve, acknowledge, and release allocated bandwidth. A single beacon may contain multiple reservation or bandwidth allocation requests and acknowledgements, with the reservation requests and the acknowledgements carried in the beacon data 360. A reservation request may specify transmission end points, periodicity, persistence, reservation type, and so forth.

Transmission end points may specify a source communications node and a destination communications node for the bandwidth allocation, while the reservation type in the reservation request may be used to specify either a hierarchical or an ad hoc reservation request. A bandwidth allocation may have a specified persistence (e.g., one or more transmission and reception periods) or it may have an unspecified persistence (e.g., undefined duration, lasting until terminated). Bandwidth allocation periodicity may specify a frequency of the requested bandwidth allocation (e.g., every other transmission and reception period). Additionally, in a situation where it may be difficult to predict the amount of bandwidth needed, bandwidth allocations may always request a fixed amount of bandwidth.

A hierarchical reservation type may specify the duration of the reservation, owner of the reservation (e.g., a communication node making a bandwidth allocation request) and a group of communications nodes. The owner of the reservation specifies the detailed capacity allocations for each transmission turn by using a common control channel (“CCC”). The capacity allocations specify the used capacity from owner to communications nodes (e.g., a downlink (“DL”) transmission), from communications nodes to owner (an uplink (“UL”) transmissions) and capacity for contention based random access channel (“CRAC”), which may be used by the communications nodes use to request uplink capacity from the reservation owner.

The acknowledgement subframe 330 may be fixed length and uses code multiplexing to reduce resource consumption as well as transmission turns. The acknowledgement subframe 330 may add flexibility and increase the speed of the three-way handshake mechanism presented in the IEEE standard 802.16. An owner of a reservation may request a reservation of bandwidth, then communications nodes in the ad hoc wireless communications network that are capable of hearing the reservation and with knowledge of a possible collision may deny the allocation of the bandwidth by sending a negative acknowledgement in the acknowledgement subframe 330.

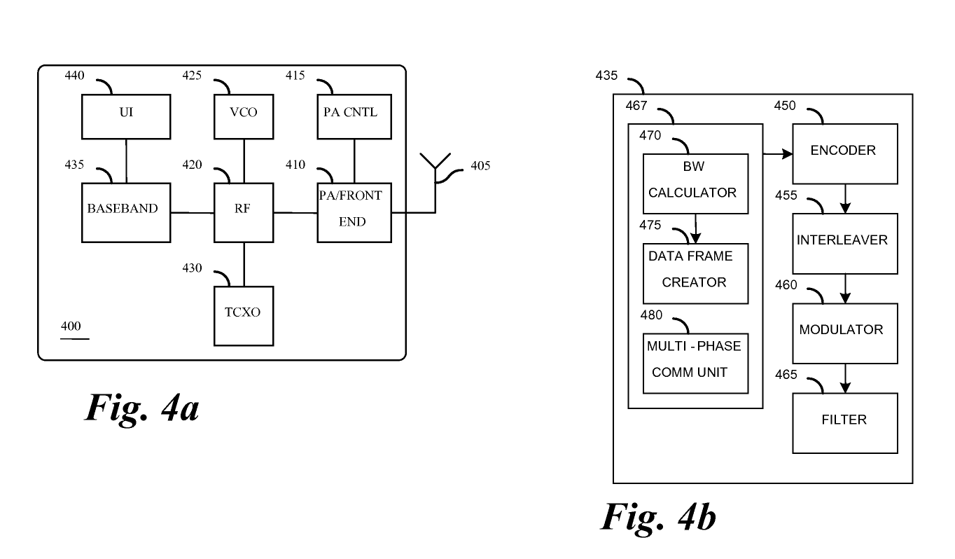

Turning now to FIGS. 4a and 4b, illustrated are diagrams of an embodiment of a wireless communications device 400 for use in an ad hoc wireless communications network in accordance with the principles of the present invention. The wireless communications device 400 includes an antenna 405 for receiving and transmitting signals over-the-air. Although a single antenna is shown in FIG. 4a, multiple antennas may be used by the wireless communications device 400 to improve wireless performance. The discussion that follows provides an exemplary operation of the wireless communications device 400 after receiving a signal and the subsequent processing thereof. Also, the wireless communications device 400 may serve, at least in part, as a communications node as described herein.

The received signal, transmitted over-the-air and received by the antenna 405, may then be provided to a power amplifier (“PA”) and front end unit 410. The PA and front end unit 410 may be used to amplify the received signal so that it may be within a signal level range that may be compatible with a remainder of signal processing components in the wireless communications device 400. A PA control unit 415 may be used to adjust the amplification of the PA and front end unit 410 so that the received signal receives a proper amount of signal amplification. A radio frequency (“RF”) unit 420 may then be used to perform signal processing on the amplified received signal. The RF unit 420 may perform processing operations such as filtering the amplified received signal to eliminate out of band noise and interference, and so forth. Additionally, the RF unit 420 may be used to demodulate the amplified received signal, remove a carrier frequency and bring the amplified received signal down to its baseband frequency, thus producing a baseband signal. Oscillators, such as voltage controlled oscillators (“VCO”) 425 or temperature controlled crystal oscillators (“TCXO”) 430 may be used to provide needed frequency references.

Once brought down to its baseband frequency, the baseband signal may be provided to a baseband unit 435. The baseband unit 435 may be used to provide signal processing of the baseband signal and may perform the signal processing in both a digital and an analog domain. The baseband unit 435 may perform analog signal processing operations such as filtering, amplification, and so forth. The baseband unit 435 may also perform digital signal processing operations such as radio protocol control, error detection/correction, deinterleaving, filter, amplification, and so forth. Additionally, the baseband unit 435 may also be used to interface with applications (e.g., Internet browser, e-mail or peer-to-peer applications), which provide data to a user interface (“UI”) 440 of the wireless communications device 400. The UI 440 may include keypad, display, memory, microphone, speakers, wired headsets, and so on. Furthermore, the baseband unit 435, as shown in FIG. 4b may be used to disassemble frames or packets from the digitized baseband signal to extract data from received frames or packets.

Similarly, the wireless communications device 400 may be used to transmit frames or packets including data. Data to be transmitted, such as data that may be used to setup a hierarchical network in an ad hoc wireless communications network or data transmissions in the hierarchical network, may receive processing in the baseband unit 435. The processing may include interleaving, error encoding, filtering, and so forth. Error encoding may involve the application of an error correcting code by an encoder 450 to data to be transmitted to help protect the data from damage caused by noise and interference. An interleaver 455 may reorder the data to be transmitted, which may have already been error encoded to help reduce the probability of consecutive data bits being corrupted. Interleaved data produced by the interleaver 455 may then be modulated by a modulator 460. A filter 465 may be used to shape spectral characteristics of the data to be transmitted, which may have also been error encoded and interleaved. For the purposes of the discussion herein, a transceiver that forms a transmitter and receiver for the wireless communications device 400 includes, in part, at least a portion of the PA and front end unit 410, the PA control unit 415, the RF unit 420, and the VCO 425 and TCXO 430. Of course, a transceiver and other wireless communications device functions may be embodied in other systems and subsystems as well.

Turning now to FIG. 4b, illustrated is a diagram of an embodiment of a baseband unit 435 employable in the wireless communications device 400 of FIG. 4a. The baseband unit 435 includes a controller 467, which in addition to controlling the overall operation of the wireless communications device 400, may also be used to create bandwidth allocation requests for creating a hierarchical network in the ad hoc wireless communications network. The bandwidth allocations may extend over one or more transmission and reception time periods and the bandwidth allocations are made for an allocation of transmission and reception slots between communications nodes in the hierarchical network. The controller 467 includes a bandwidth calculator 470 that may be used to compute a needed bandwidth allocation to support the communications in the hierarchical network. The bandwidth calculator 470 may listen to bandwidth allocation requests made in accordance with the control subframe 210, for example, to determine bandwidth allocation requests from communications nodes in the hierarchical network. The bandwidth calculator 470 may then calculate an aggregate bandwidth needed by the hierarchical network.

The controller 467 may then make use of the aggregate bandwidth in the creation of a bandwidth allocation request that it transmits to communications nodes in the ad hoc wireless communications network. A frame creator 475 may be used to properly format the packets or frames (e.g., control and data frames) for the bandwidth allocation request or otherwise, which may include information such as specific transmission end points, periodicity, persistence, reservation type, and so forth. A multi-phase communications unit 480 may be used to control the transmissions of frames (e.g., data frames) based on multiple phases of a phased communications mode of a hierarchical network or of a hierarchical network operating mode. Phased communications may involve controlling which transmissions may be permissible at a given communications phase. For example, during a given phase, transmissions may be permitted only along a specified direction, while all other transmissions may be prohibited. Thus, the controller 467 may restrict transmissions and receptions between communications nodes in the hierarchical network, wherein the restrictions are specified in a phase of a phased communications mode as set forth below.

The data frame may then be converted into analog signals, which may also be processed in the baseband unit 435, which may filter, amplify, and so forth, the analog signals. The RF unit 420 may be used to apply a carrier frequency to the analog signals for transmission purposes. The RF unit 420 may also apply filters to help ensure that transmissions meet spectral requirements, and so forth. Finally, the PA and front end unit 410 may be used to amplify the analog signals to power levels suitable for transmission via the antenna 405.

In accordance with the bandwidth allocation requests described above, the transceiver of the wireless communications device 400 may receive request grants from a communications node granting the bandwidth allocation requests and, in cooperation with the controller 467 of the baseband unit 435, transmit an acknowledgement to the communications node, thereby establishing a hierarchical network operating mode in the ad hoc wireless communications network Additionally, the transceiver may receive a negative acknowledgement from another communications node having a conflict with the bandwidth allocations, and the transceiver, in cooperation with the controller 467 of the baseband unit 435, may cancel the bandwidth allocation requests.

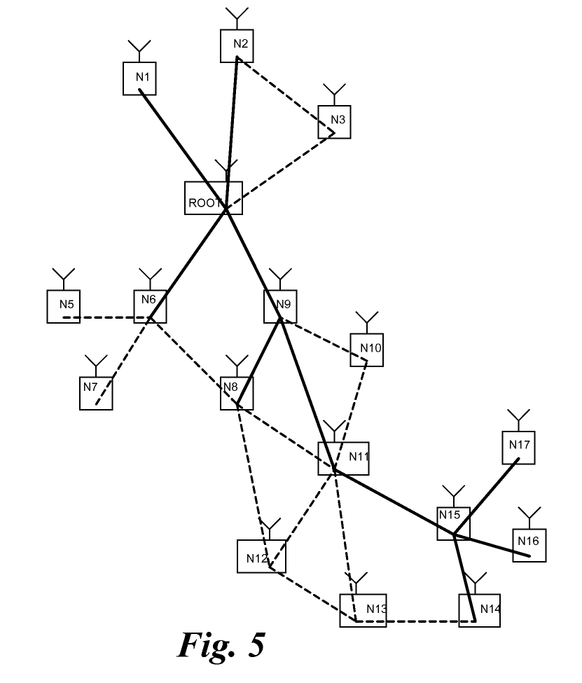

Turning now to FIG. 5, illustrated is a diagram of an embodiment of a hierarchical network overlaying an ad hoc wireless communications network in accordance with the principles of the present invention. The hierarchical network is represented by the solid lines that connect ones of the communications nodes, namely, communications nodes N1, N2, ROOT, N6, N8, N9, N11, N14, N15, N16, N17. The hierarchical network includes a root communications node. The root communications node may serve as a controller for setting up the hierarchical network as well as controlling the transmissions of communications nodes therein. The root communications node may also be coupled to a wired infrastructure and may provide connectivity to the Internet or a private network, for example.

Although the root communications node and the communications nodes in the hierarchical network may be operating using a hierarchical network operating mode, the root communications node as well as the communications nodes in the hierarchical network may also remain members of the ad hoc wireless communications network. Depending on implementation, a communications node that is in both networks (the hierarchical network and the ad hoc wireless communications network) may simultaneously or sequentially communicate to other communications nodes using either the hierarchical or ad hoc network operating method.

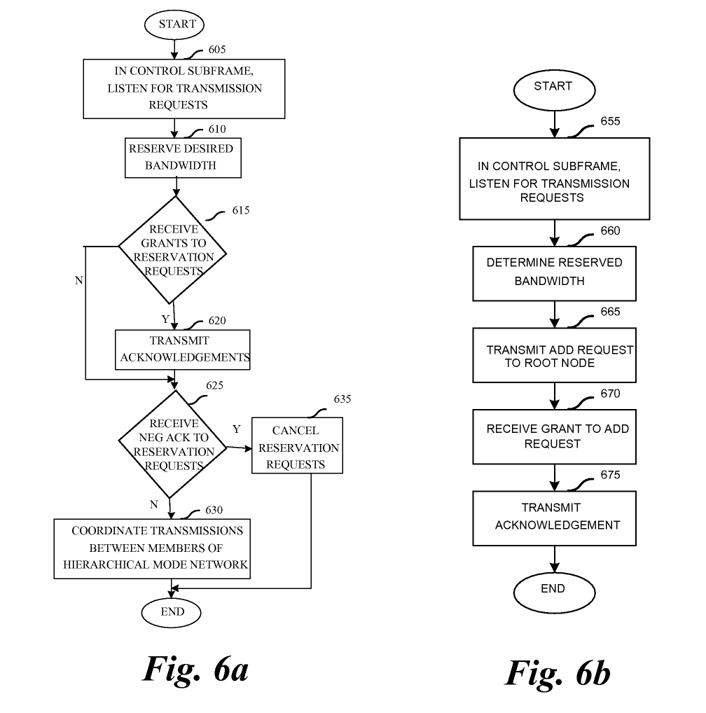

Turning now to FIG. 6a, illustrated is a diagram of an embodiment of a sequence of events in creating a hierarchical network in an ad hoc wireless communications network in accordance with the principles of the present invention. The creation of a hierarchical network in an ad hoc wireless communications network may begin with communications nodes in the ad hoc wireless communications network listening within a control subframe, such as the control subframe 310 of FIG. 3, for transmission requests at a step 605. A communications node listening for the transmission requests may be a communications node that will become a root communications node of the hierarchical network. The root communications node may listen for transmission requests to determine available bandwidth or compute required bandwidth of the hierarchical network, for example.

In addition to listening for transmission requests within the control subframe, communications nodes in the ad hoc wireless communications network may also listen for other information transmitted during the control subframe. An example of other information transmitted during the control subframe may be information regarding persistent bandwidth allocations (e.g., bandwidth allocations that last for more than one transmit and receive period). In addition to its use by communications nodes operating in a hierarchical network operating mode, the control subframe may also be used by communications nodes operating in an ad hoc network operating mode.

Any communications node in the ad hoc wireless communications network may become a root communications node of a hierarchical network. Additionally, any child node in a hierarchical network may become a root communications node of the hierarchical network or create its own hierarchical network. Furthermore, a communications node of the ad hoc wireless communications network that is not a member of a hierarchical network may join the hierarchical network.

After listening for transmission requests in accordance with a control subframe, the root communications node may then make its own requests to reserve bandwidth (e.g., bandwidth allocations request) from communications nodes in the ad hoc wireless communications network that may become its child communications nodes at a step 610. Requests to reserve bandwidth may include information such as transmission type (e.g., hierarchical or dynamic), duration (e.g., amount of bandwidth required), communications nodes (e.g., child communications nodes) of the hierarchical network, and so forth. The request to reserve bandwidth may be transmitted to every communications node intended to be a member of the hierarchical network plus communications nodes that may be part of a one hop neighborhood with the root communications node. Therefore, the requests to reserve bandwidth may be transmitted to communications nodes that are not part of the hierarchical network.

After making the requests to reserve bandwidth, the root communications node may listen for grants of the requested bandwidth at a step 615. If a communications node (e.g., a child communications node) grants the request for bandwidth, then the root communications node may add the child communications node to the hierarchical network and transmit an acknowledgment to each child communications node that grants the request for bandwidth at a step 620. If the child communications node does not grant the request for bandwidth, then the root communications node may eliminate the child communications node from the hierarchical network. The root communications node may also check for the reception of a negative acknowledgement at a step 625. A discussion of a negative acknowledgement is provided below. If the root communications node does not receive a negative acknowledgement and receives grants from all child communications node of the bandwidth reservation requests, the root communications node may then coordinate transmissions between communications nodes of the hierarchical network at a step 630.

If a child communications node or another communications node in the ad hoc wireless communications that may or may not be an intended communications node in the hierarchical network knows of scheduled transmissions or bandwidth allocations that may conflict with the bandwidth reservation requests transmitted by the root communications node, then the communications node receiver may transmit a negative acknowledgement to the root communications node. The child communications node or another communications node may know of such scheduled transmissions or bandwidth allocations due to its detection of reservation requests for the scheduled transmissions or bandwidth allocations from its own one hop neighborhood, which may not have been detected by the root communications node. The root communications node may thereby attain knowledge of its two hop neighborhood, as it does when making its ad hoc reservations. When the root communications node receives the negative acknowledgement at the step 625, the root communications node may elect to cancel the bandwidth reservation requests and any bandwidth that may already have been allocated at a step 635. After canceling the bandwidth reservation or allocation requests, the root communications node may repeat its attempt to create the hierarchical network, perhaps with a smaller or a different bandwidth allocation. For example, the root communications node may make a bandwidth allocation request in a different frequency band or time slot.

Turning now to FIG. 6b, illustrated is a diagram of an embodiment of a sequence of events in adding a communications node to an existing hierarchical network in accordance with the principles of the present invention. In addition to creating a hierarchical network in the ad hoc wireless communications network, a communications node in the ad hoc wireless communications network may join an existing hierarchical network. The sequence of events of FIG. 6b illustrates events used by a communications node in the ad hoc wireless communications network to join an existing hierarchical network. When a communications node wishes to join an existing hierarchical network, at a step 655 the communications node may listen within a control subframe, such as the control subframe 210 of FIG. 2 or the control subframe 310 of FIG. 3, to determine the bandwidth allocation for the existing hierarchical network at a step 660. The communications node may then transmit a request to a communications node operating as a root communications node of the existing hierarchical network to add the communications node to the existing hierarchical network at a step 665. If the communications node receives a grant transmission from the communications node operating as the root communications node at a step 670, then the communications node has been added to the existing hierarchical network and the communications node may transmit an acknowledgement back at a step 675.

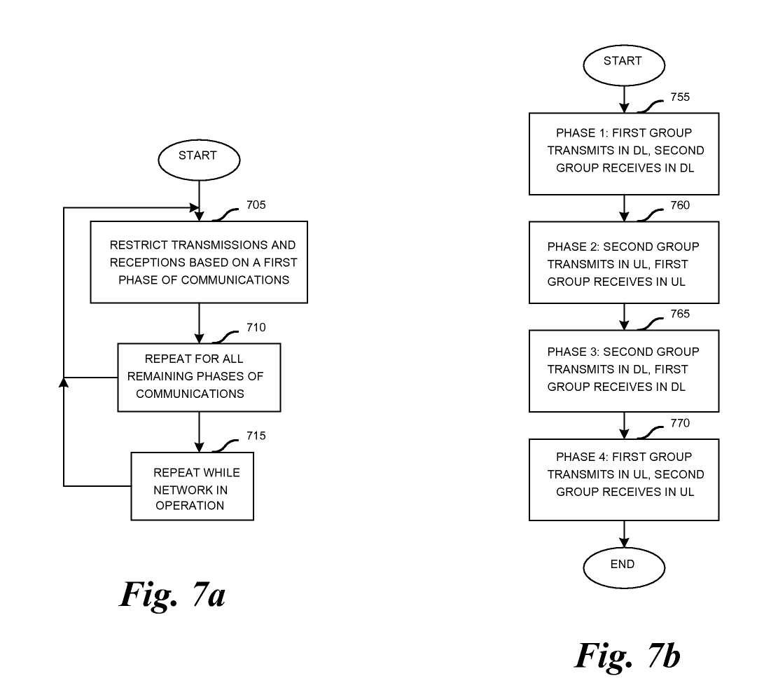

Turning now to FIG. 7a, illustrated is a diagram of an embodiment of a high-level sequence of events in a phased communications mode of a hierarchical network overlaying an ad hoc wireless communications network in accordance with the principles of the present invention. A hierarchical network may be logically arranged into a tree topology, with a single root, such as the root communications node. The root communications node in the ad hoc wireless communications network may use MSH-DSCH messages in accordance with a control subframe, such as control subframe 310 of FIG. 3, to request a persistent allocation of bandwidth from other communications nodes in the ad hoc wireless communications network. The communications nodes that the root communications node is requesting the bandwidth allocation from may be the intended child communications nodes of the root communications node. While the allocation of the bandwidth allows the setup of point-to-point transmissions, the actual execution of the point-to-point transmissions may not be specified.

A prioritized system may be utilized for bandwidth allocation requests that may enable an overriding of existing bandwidth allocation requests. The prioritized system may be organized so that if a communications node in the hierarchical network has a connection to an external network (such as the Internet), communications nodes that are closer to the communications node having the connection may be given a higher priority than communications nodes that are farther away. The bandwidth allocation requests may also be prioritized by application type. For example, bandwidth allocation requests associated with time crucial applications such as voice over Internet protocol (“VoIP”), video conferencing, monitoring, gaming, and so forth, may be given priority over less time crucial applications.

When there is information to transmit, the root communications node transmits downstream information (e.g., information over a communications link from a communications node higher in the hierarchy of the hierarchical network to a communications node lower in the hierarchy) to its child communication nodes and accepts upstream information (e.g., information over a communications link from a communications node lower in the hierarchy of the hierarchical network to a communications node higher in the hierarchy) from its child communication nodes, with the transmissions occurring within the allocated bandwidth. If there is no information to transmit, the allocated bandwidth may still occupy spectrum and may prevent any other communications nodes from utilizing the allocated bandwidth.

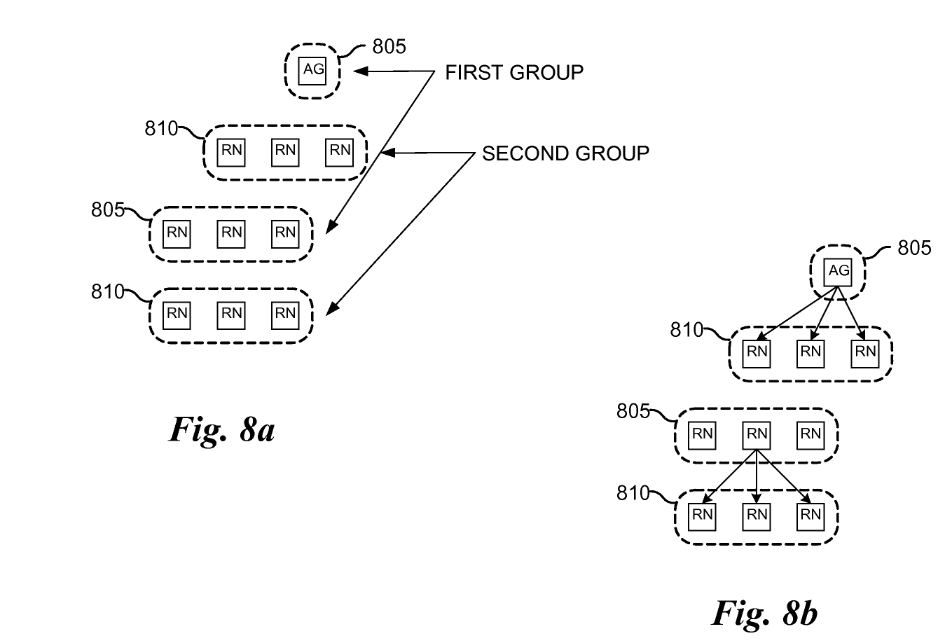

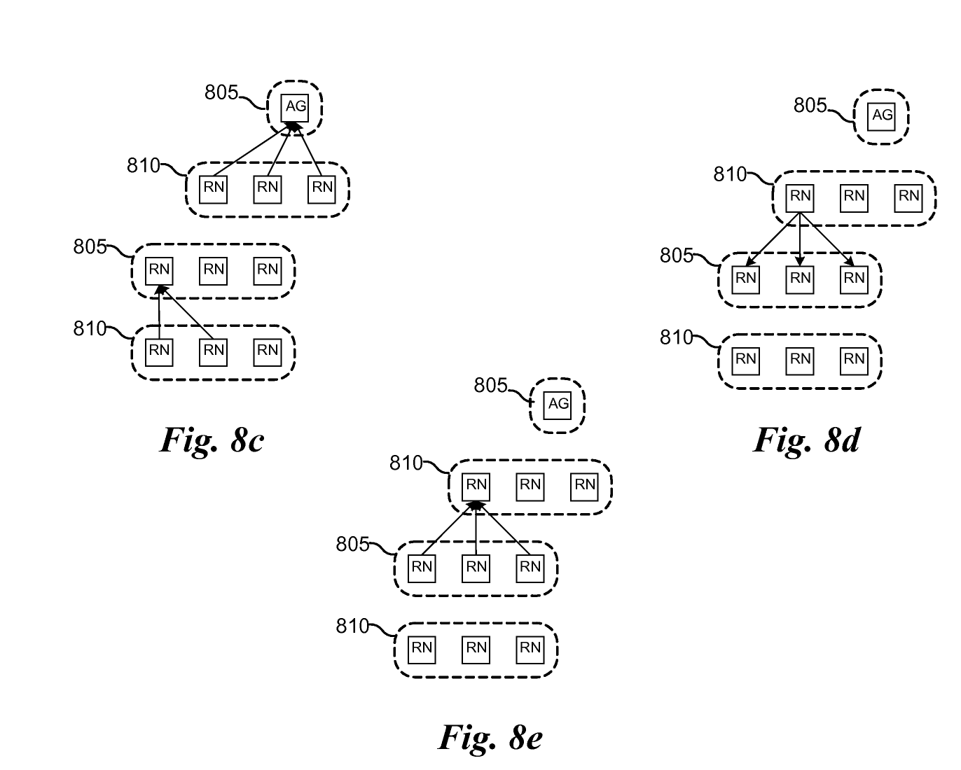

It may be possible to partition the hierarchical network to speed up operation and to reduce interference to other communications nodes in the ad hoc wireless communications network. With reference to FIG. 8a, illustrated is a diagram of an embodiment of a partitioning of a hierarchical network into two groups (e.g., a two hop neighborhood) in accordance with the principles of the present invention. The hierarchical network may be organized into a two hop neighborhood with a root communications node and any second layer communications nodes (e.g., communications nodes that are two transmission hops away from the root communications node) being grouped into a first group of communications nodes 805. Any first layer communications nodes (e.g., communications nodes that are one transmission hop away from the root communications node) may be grouped into a second group of communications nodes 810. Communications nodes that are in a third layer, if present, may be grouped into the second group of communications nodes 810, and communications nodes in a fourth layer may be grouped into the first group of communications nodes 805, and so forth.

The phased communications mode may involve placing restrictions on transmissions and receptions between different groups of communications nodes, such as the first group of communications nodes 805 and the second group of communications nodes 810, to help reduce transmission collisions that may negatively impact network performance. Each different phase of the phased communications mode may place different restrictions on transmissions and receptions. Transmission and reception phases predefined by persistent allocations allow communications nodes from one layer to transmit to and receive from communications node in the next layer wherein there may be an established communications link between communications nodes. Thus, a transmitting/receiving communications node can utilize sophisticated multi-user multiple-input multiple-output (“MIMO”) techniques (e.g., multi-user precoding in downlink and spatial division multiple access in uplink direction) to enhance the system capacity. This may especially be important close to the root communications node wherein the information from the lower layers will accumulate and high spectral efficiency is preferable. The phased communications mode may also allow for easy integration of a power save mode for the communications nodes.

Returning now to FIG. 7a, and with continuing reference to FIG. 8a, the phased communications mode may begin by restricting communications between communications nodes from the first group of communications nodes 805 to the second group of communications nodes 810 and vice versa, according to a first phase of communications at a step 705. While operating in the first phase of communications, the permitted transmissions and receptions are those adherent to the permissible communications allowed in the first phase of communications. When the first phase of communications is completed, restricted communications may continue as specified by any remaining phases of communications at a step 710. The restrictions of the remaining phases of communications may be applied individually based on some specified order. For example, if there are a total of four phases of communications, then exemplary order of application of the four phases of communications may be [phased_1, phase_2, phase_3, phase_4], [phase_4, phase_3, phase_2, phased_1], [phase_1, phase_3, phase_2, phase_4], and so on.

Durations of the individual phases of communications may be about equal in duration or each individual phase of communications may have a different duration, with the duration being dependent on factors such as expected information profile, upstream/downstream bandwidth, noise/interference on upstream/downstream links, and so forth. After the restrictions of all of the individual phases of communications have been applied, the applications of the phases of communications may be repeated while the hierarchal network continues in operation in a step 715.

Turning now FIG. 7b, illustrated is a diagram of an embodiment of a sequence of events in a four-phased communications mode of a hierarchical network overlaying an ad hoc wireless communications network in accordance with the principles of the present invention. The phased communications mode may be as set forth below. In a phase_1, the communications nodes in a first group of communications nodes 805 (e.g., including a root communications node) may transmit over downstream links (e.g., a communications link from a communications node higher in the hierarchy of the hierarchical network to a communications node lower in the hierarchy) and the communications nodes in the second group of communications nodes 810 may receive over downstream links at a step 755. In a phase_2, the communications nodes in the second group of communications nodes 810 may transmit over upstream links (e.g., a communications link from a communications node lower in the hierarchy of the hierarchical network to a communications node higher in the hierarchy) and the communications nodes in the first group of communications nodes 805 may receive over upstream links at a step 760. In a phase_3, the communications nodes in the second group of communications nodes 810 may transmit over downstream links and the communications nodes in the first group of communications nodes 805 may receive over downstream links at a step 765. In a phase_4, the communications nodes in the first group of communications nodes 805 may transmit over upstream links and the communications nodes in the second group of communications nodes 810 may receive over upstream links at a step 770. Each of the four phases of communications may exist within a single data subframe, such as the data subframe 340 of FIG. 3.

Turning now to FIGS. 8b through 8e, illustrated are diagrams of embodiments of permissible communications in each phase of a four-phased communications mode in accordance with the principles of the present invention. More specifically, FIGS. 8b through 8e illustrate transmissions between a first group of communications nodes 805 and the second group of communications nodes 810 according to the phased communications mode according to phased_1 through phase_4, respectively, as described above. Although the discussions disclose a specific order of transmissions between communications nodes in the first group of communications nodes 805 and communications nodes in the second group of communications nodes 810, alternative orderings of the transmissions may be possible. Therefore, the discussions should not be construed as being limiting to either the scope or the spirit of the present invention.

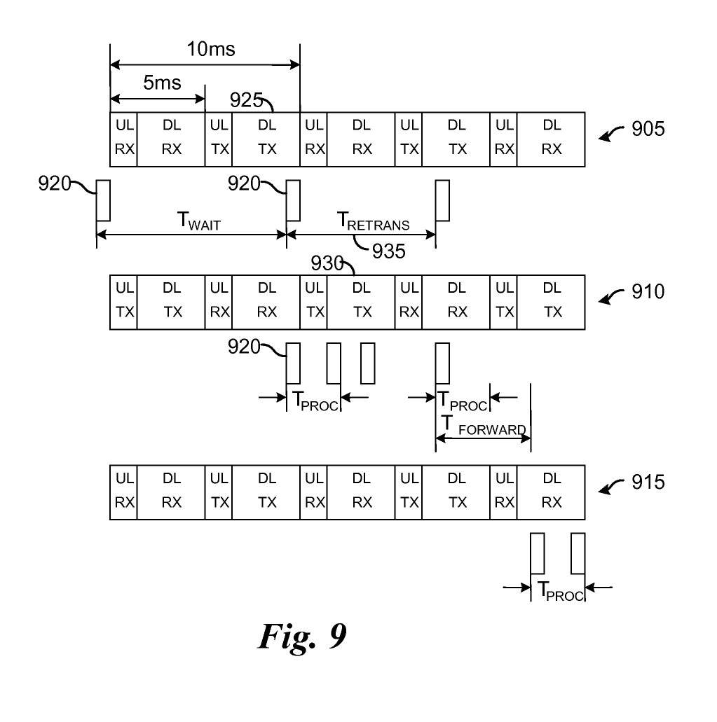

Turning now to FIG. 9, illustrated is a diagram of an embodiment of a packet flow using a four-phased communications mode in accordance with the principles of the present invention. For discussion purposes, assumptions include a frame duration of 10 milliseconds (“ms”), which is an example of an option in the IEEE standard 802.16. A first phase sequence 905 illustrates upstream and downstream transmissions and receptions for a root communications node, a second phase sequence 910 illustrates upstream and downstream transmissions and receptions for communications nodes one hop away from the root communications node, and a third phase sequence 915 illustrates upstream and downstream transmissions and receptions for communications nodes two hops away from the root communications node, according to a phased communications mode as described above with respect to FIG. 7b.

A packet (also referred to as a frame) 920 arrives at the root communications node. The packet 920 does not leave the root communications node until a next downstream transmit period in the first phase sequence 905, shown as a first downstream transmit phase 925. Therefore, a waiting time until a first transmission opportunity may be as long as T_{WAIT}=7.5 ms (D_{ULRX}+D_{DLRX}+D_{ULTX}), wherein D_{ULRX} is the duration of the upstream receive phase, D_{DLRX} is the duration of the downstream receive phase, and D_{ULTX} is the duration of the upstream transmit phase, with an assumption that each phase in the phased communications mode is about equal in duration.

A communications node one hop away from the root communications node may receive the packet 920. Then, the communications node may forward the packet 920, assuming that the packet 920 was received correctly, in a next downstream transmit phase in the second phase sequence 910, shown as a second downstream transmit phase 930. There may be a forwarding delay (“T_{FORWARD}”) that may be equal to about 5 ms. If retransmissions are not required, then an overall delay may be expressible as:

Delay=T_{WAIT}+(#HOPS−1)×T_{FORWARD}+T_{PROC},

where #HOPS is the number of hops between the root communications node and an intended recipient of the transmission and T_{PROC} is a processing time. Then, the Delay is about equal to 14.5 ms for #HOPS=2, 19.5 ms for #HOPS=3, and 24.5 ms for #HOPS=4.

If retransmissions are required, however, the situation may be significantly different. When a retransmission is required, a communications node may not retransmit until all phases in the phased communications mode have passed (e.g., a full frame has elapsed), so a time for retransmission, T_{RETRANS}=10 ms if a negative acknowledgement was sent in time. This is shown in FIG. 9 as interval 935. In situations where the phases in the phased communications mode have different durations, the next suitable phase may not have sufficient duration to process the packet 920 and send a negative acknowledgement. For a packet 920 sent to a communications node one hop away from the root communications node, the packet 920 may only be sent at a next available upstream transmit phase. Assuming a 1:9 ratio of the phase durations, the communications node has to send the negative acknowledgement within 0.5 ms.

Thus, the present invention provides a system and method for a hierarchical network operating mode in an ad hoc wireless communications network. In one embodiment, a communications node includes a controller configured to request bandwidth allocations from a first group of communications nodes in an ad hoc wireless communications network. The bandwidth allocations extend over one or more transmission and reception time periods and the bandwidth allocations are made for an allocation of transmission and reception slots to a second group of communications nodes. The communications node also includes a transceiver configured to receive request grants from a communications node in the first group of communication nodes granting the bandwidth allocation requests and transmit an acknowledgement to the communications node in the first group of communication nodes, thereby establishing a hierarchical network operating mode in at least a portion of the ad hoc wireless communications network.

The communications node in the first group of communications nodes may be one hop from the communications node requesting the bandwidth allocations. Also, the transceiver may be configured to receive a negative acknowledgement from another communications node in the first group of communications nodes having a conflict with the bandwidth allocations. The transceiver is also configured to listen to a transmission in a control channel for transmission requests and the controller is configured to compute the bandwidth allocations before requesting the same. The bandwidth allocations as described herein may include at least one of bandwidth allocation type, bandwidth allocation persistence, and bandwidth allocation priority.

The controller of the communications node may also include a bandwidth calculator configured to compute the bandwidth allocations, a frame creator configured to format frames (e.g., data or control frames) for use in requesting the bandwidth allocations, and a multi-phase communications unit configured to restrict transmissions as a function of a phase of a phased communications mode. The controller may also be a part of a baseband unit that further includes an encoder configured to apply an error correcting code to data to be transmitted, an interleaver configured to interleave data to be transmitted, and a filter configured to filter data to be transmitted to provide spectral shaping.

In another aspect, a method establishes a hierarchical network operating mode in at least a portion of an ad hoc wireless communications network. The method includes requesting bandwidth allocations from a first group of communications nodes in the ad hoc wireless communications network. The bandwidth allocations extend over one or more transmission and reception time periods and the bandwidth allocations are made for an allocation of transmission and reception slots to a second group of communications nodes. The method also includes receiving request grants from a communications node in the first group of communications nodes granting the bandwidth allocation requests, and transmitting an acknowledgement to the communications node in the first group of communications nodes.

The act of requesting above may also include requesting bandwidth allocations that are about equal to an expected bandwidth usage of communications nodes in the hierarchical network or of a fixed length for communications nodes in the hierarchical network. The communications node in the first group of communications nodes may be one hop from a communications node requesting the bandwidth allocations. The aforementioned method may also include receiving a negative acknowledgement from another communications node in the first group of communications nodes having a conflict with the bandwidth allocations. The method may also include listening to a transmission in a control channel for transmission requests and computing the bandwidth allocations before requesting the same. A communications node in one of the first and second groups of communications nodes may operate in an ad hoc network operating mode. The bandwidth allocation may include at least one of bandwidth allocation type, bandwidth allocation persistence, and bandwidth allocation priority.

In another aspect, a communications node includes a controller configured to assemble packets for requesting bandwidth allocations in an ad hoc wireless communications network to create a hierarchical network and for restricting transmissions and receptions between communications nodes in first and second groups of communications nodes in the hierarchical network. The restrictions are specified in a phase of a phased communications or phased communications mode. The communications node also includes a transceiver configured to transmit the packets to the communication nodes of the first and second groups of communications nodes.

The aforementioned phase may be one of a first, second, third and fourth phase of the phased communications mode. The first phase of the phased communications mode includes transmitting packets in a downstream communications link from a communications node in the first group of communications nodes to a communications node in the second group of communications nodes. The second phase of the phased communications mode includes transmitting packets in an upstream communications link from a communications node in the second group of communications nodes to a communications node in the first group of communications nodes. The third phase of the phased communications mode includes transmitting packets in a downstream communications link from a communications node in the second group of communications nodes to a communications node in the first group of communications nodes. The fourth phase of the phased communications mode includes transmitting packets in an upstream communications link from a communications node in the first group of communications nodes to a communications node in the second group of communications nodes.

The controller of the communication node may include a bandwidth calculator configured to compute the bandwidth allocations, a frame creator configured to format packets for use in requesting the bandwidth allocations, and a multi-phase communications unit configured to control transmissions as a function of the phase of the phased communications mode. The controller may be part of a baseband unit that further includes an encoder configured to apply an error correcting code to data to be transmitted, an interleaver configured to interleave data to be transmitted, and a filter configured to filter data to be transmitted to provide spectral shaping. Additionally, the communications node may be a root communications node, wherein the communication nodes in the first and second groups of communications nodes are an even and odd number of hops, respectively, from the root communications node.

In another aspect, a method is provided for communicating in multiple phases in a hierarchical network overlaying an ad hoc wireless communications network. The method includes restricting transmissions and receptions between communications nodes in first and second groups of communications nodes in the hierarchical network. The restrictions are specified in a phase of a phased communications mode. The method also includes repeating the restricting for other phases of the phased communications mode.

The aforementioned may be one of a first, second, third and fourth phase of the phased communications mode. The first phase of the phased communications mode includes transmitting packets in a downstream communications link from a communications node in the first group of communications nodes to a communications node in the second group of communications nodes. The second phase of the phased communications mode includes transmitting packets in an upstream communications link from a communications node in the second group of communications nodes to a communications node in the first group of communications nodes. The third phase of the phased communications mode includes transmitting packets in a downstream communications link from a communications node in the second group of communications nodes to a communications node in the first group of communications nodes. The fourth phase of the phased communications mode includes transmitting packets in an upstream communications link from a communications node in the first group of communications nodes to a communications node in the second group of communications nodes.

In addition, program or code segments making up the various embodiments of the present invention may be stored in a computer readable medium or transmitted by a computer data signal embodied in a carrier wave, or a signal modulated by a carrier, over a transmission medium. The “computer readable medium” may include any medium that can store or transfer information. Examples of the computer readable medium include an electronic circuit, a semiconductor memory device, a ROM, a flash memory, an erasable ROM (“EROM”), a floppy diskette, a compact disk CD-ROM, an optical disk, a hard disk, a fiber optic medium, a radio frequency (“RF”) link, and the like. The computer data signal may include any signal that can propagate over a transmission medium such as electronic communication network channels, optical fibers, air, electromagnetic links, RF links, and the like. The code segments may be downloaded via computer networks such as the Internet, Intranet, and the like.

As described above, the exemplary embodiment provides both a method and corresponding apparatus consisting of various modules providing functionality for performing the steps of the method. The modules may be implemented as hardware (including an integrated circuit such as an application specific integrated circuit), or may be implemented as software or firmware for execution by a computer processor. In particular, in the case of firmware or software, the exemplary embodiment can be provided as a computer program product including a computer readable storage structure embodying computer program code (i.e., software or firmware) thereon for execution by the computer processor.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Also, many of the features, functions and steps of operating the same may be reordered, omitted, etc., and still fall within the broad scope of the present invention.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus, comprising:
a bandwidth calculator configured to compute bandwidth allocations;
a frame creator configured to format frames for use in requesting said bandwidth allocations from communications nodes in an ad hoc wireless communications network to create a hierarchical network; and
a multi-phase communications unit configured to control transmissions between said communication nodes as a function of a phase of a phased communications mode in said hierarchical network.

2. The apparatus as recited in claim 1 wherein said phase is one of multiple phases of said phased communications mode.

3. The apparatus as recited in claim 1 wherein said phase corresponds to restricting said transmissions to a downstream communications link from a communications node in a first group of communications nodes to a communications node in a second group of communications nodes.

4. The apparatus as recited in claim 1 wherein said phase corresponds to restricting said transmissions to an upstream communications link from a communications node in a second group of communications nodes to a communications node in a first group of communications nodes.

5. The apparatus as recited in claim 1 wherein said phase corresponds to restricting said transmissions to a downstream communications link from a communications node in a second group of communications nodes to a communications node in a first group of communications nodes.

6. The apparatus as recited in claim 1 wherein said phase corresponds to restricting said transmissions to an upstream communications link from a communications node in the first group of communications nodes to a communications node in the second group of communications nodes.

7. The apparatus as recited in claim 1 wherein said bandwidth allocation comprises at least one of bandwidth allocation type, bandwidth allocation persistence, and bandwidth allocation priority.

8. A computer program product comprising program code stored in a computer readable medium configured to compute bandwidth allocations, format frames for use in requesting said bandwidth allocations from communications nodes in an ad hoc wireless communications network to create a hierarchical network, and control transmissions between said communication nodes as a function of a phase of a phased communications mode in said hierarchical network.

9. The computer program product as recited in claim 8 wherein said program code stored in said computer readable medium is restrict said transmissions to a downstream or an upstream communications link from a communications node in a first group of communications nodes to a communications node in a second group of communications nodes.

10. The computer program product as recited in claim 8 wherein said program code stored in said computer readable medium is restrict said transmissions to a downstream or an upstream communications link from a communications node in a second group of communications nodes to a communications node in a first group of communications nodes.

11. A method of operating an apparatus, comprising:
computing bandwidth allocations;
formatting frames for use in requesting said bandwidth allocations from communications nodes in an ad hoc wireless communications network to create a hierarchical network; and
controlling transmissions between said communication nodes as a function of a phase of a phased communications mode in said hierarchical network.

12. The method as recited in claim 11 wherein said controlling comprises restricting said transmissions to a downstream communications link from a communications node in a first group of communications nodes to a communications node in a second group of communications nodes.

13. The method as recited in claim 11 wherein said controlling comprises restricting said transmissions to an upstream communications link from a communications node in a second group of communications nodes to a communications node in a first group of communications nodes.

14. The method as recited in claim 11 wherein said controlling comprises restricting said transmissions to a downstream communications link from a communications node in a second group of communications nodes to a communications node in a first group of communications nodes.

15. The method as recited in claim 11 wherein said controlling comprises restricting said transmissions to an upstream communications link from a communications node in the first group of communications nodes to a communications node in the second group of communications nodes.

16. A communications node, comprising:
a controller configured to create a bandwidth allocation request for other communications nodes in an ad hoc wireless communications network; and
a transceiver configured to receive request grants from said other communications nodes granting said bandwidth allocations in accordance with said bandwidth allocation request, thereby establishing a hierarchical network operating mode in at least a portion of said ad hoc wireless communications network.

17. The communications node as recited in claim 16 wherein said transceiver is configured to receive a negative acknowledgement from ones of said other communications nodes having a conflict with said bandwidth allocations and said controller is configured to cancel said bandwidth allocation request to said ones of said other communications nodes having said conflict with said bandwidth allocations.

18. The communications node as recited in claim 16 wherein said controller is configured to create said bandwidth allocation request in accordance with a transmission request from another communications node in said ad hoc wireless communications network.

19. The communications node as recited in claim 16 wherein said communications node is configured to coordinate transmissions to said other communications nodes.

20. The communications node as recited in claim 16 wherein said bandwidth allocations may extend over one or more transmission and reception time periods and said bandwidth allocations are made for an allocation of transmission and reception slots between said communications node and said other communications nodes.

21. The communications node as recited in claim 16 wherein said controller comprises a bandwidth calculator configured to compute bandwidth allocations to support transmissions to said other communications nodes.

22. The communications node as recited in claim 16 wherein said controller comprises a multi-phase communications unit configured to control transmissions based on multiple phases of phased communications in accordance with said hierarchal network operating mode

23. The communications node as recited in claim 16 wherein said controller is configured to restrict transmissions to ones of said other communications nodes specified in a phase of phased communications in accordance with said hierarchal network operating mode.

24. The communications node as recited in claim 16 wherein said bandwidth allocation request is embodied in a control subframe having a beacon subframe and an acknowledgement subframe.

25. The communications node as recited in claim 16 wherein said bandwidth allocation request comprises at least one of bandwidth allocation type, bandwidth allocation persistence, and bandwidth allocation priority.

26. A method of operating a communications node, comprising:
creating a bandwidth allocation request for other communications nodes in an ad hoc wireless communications network; and
receiving request grants from said other communications nodes granting said bandwidth allocations in accordance with said bandwidth allocation request, thereby establishing a hierarchical network operating mode in at least a portion of said ad hoc wireless communications network.

27. The method as recited in claim 26, further comprising:
receiving a negative acknowledgement from ones of said other communications nodes having a conflict with said bandwidth allocations; and
canceling said bandwidth allocation request to said ones of said other communications nodes having said conflict with said bandwidth allocations.

28. The method as recited in claim 26 wherein said creating said bandwidth allocation request is in response to a transmission request from another communications node in said ad hoc wireless communications network.

29. The method as recited in claim 26, further comprising coordinating transmissions to said other communications nodes including restricting transmissions to ones of said other communications nodes specified in a phase of a phased communications mode in said hierarchical network.

30. The method as recited in claim 26 wherein said bandwidth allocation request comprises at least one of bandwidth allocation type, bandwidth allocation persistence, and bandwidth allocation priority.
